(19) United States
(12) Patent Application Publication
(10) Pub. No.: US 2016/0298063 A1
(43) Pub. Date: Oct. 13, 2016

(54) DISPOSABLE DISHWASHING PAD

(71) Applicant: Henkel AG & Co. KGaA, Duesseldorf (DE)

(72) Inventors: Sandra Behr, Hilden (DE); Gabriele Huertgen, Duesseldorf (DE); Tobias Segler, Duesseldorf (DE)

(73) Assignee: Henkel AG & Co. KGaA, Duesseldorf (DE)

(21) Appl. No.: 15/183,381

(22) Filed: Jun. 15, 2016

Related U.S. Application Data
(63) Continuation of application No. PCT/EP2014/078279, filed on Dec. 17, 2014.

(30) Foreign Application Priority Data
Dec. 18, 2013 (DE) 10 2013 226 512.3

(51) Int. Cl. C11D 17/04; B08B 3/10; B08B 1/00; C11D 3/40; A47L 17/00

(52) U.S. Cl. CPC C11D 17/049; C11D 3/40; A47L 17/00; B08B 1/006; B08B 3/10

(57) ABSTRACT

The present invention relates to a dishwashing pad for one-time use for manually washing dishes, wherein the dishwashing pad is coated with a dishwashing agent. The present invention further relates to the use of this dish pad and a method for manually washing dishes by using this dish pad.

### FIELD OF THE INVENTION

The present invention generally relates to a dishwashing pad for one-time use for manually washing dishes, wherein the dishwashing pad is coated with a dishwashing agent. The present invention further relates to the use of this dish pad and a method for manually washing dishes by using this dish pad.

### BACKGROUND OF THE INVENTION

In manual dishwashing, dishwashing agents are typically used in combination with an implement for applying the dishwashing agent, typically a brush, a sponge, or a dishwashing pad. In accordance with consumer behavior, this application implement is rinsed off after use and stored near the sink until the next use. However, because food residues and other soiling remain on the implement, the implement provides a breeding ground for bacteria. Actually, consumers are well aware of this problem, and such dish sponges and dishcloths are often rated as one of the least hygienic items in the household.

Adding antibacterial additives to dishwashing agents or providing corresponding implements for application, i.e., sponges or cloths, as disposable implements for one-time use or for use for a limited period of time or a limited number of uses is known as a way to confront this problem.

Consumers also find it disadvantageous that widely different implements, such as a dishwashing brush, a dishwashing pad, and a bottle having dishwashing agent, are required for manual dishwashing.

Therefore, the problem addressed by the present invention is that of providing a dishwashing pad that overcomes the disadvantages mentioned above and meets the needs of consumers with regard to hygiene and simplicity of use.

This problem is solved by means of a dishwashing pad according to a first aspect of the invention. The dishwashing pad described herein is intended for one-time use in manual dishwashing and is distinguished in that at least one surface of the dishwashing pad, more particularly one side, preferably both sides, is at least partially coated with a dishwashing agent.

Furthermore, other desirable features and characteristics of the present invention will become apparent from the subsequent detailed description of the invention and the appended claims, taken in conjunction with this background of the invention.

### BRIEF SUMMARY OF THE INVENTION

A dishwashing pad, which is intended for one-time use for manually washing dishes, characterized in that at least one surface of the dishwashing pad is at least partially coated with a dishwashing agent, wherein the dishwashing agent coating has a visually perceptible indicator, more particularly a dye or a dye mixture, that indicates the consumption of the dishwashing agent and/or the end of the usage cycle.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In various embodiments, the dishwashing agent coating can have a visually perceptible indicator, more particularly a dye or a dye mixture, that indicates the consumption of the dishwashing agent and/or the end of the usage cycle.

For this purpose, the visually perceptible indicator can be selected in such a way that the indicator is removed from the dishwashing pad during the dishwashing, particularly together with and to the same extent as the dishwashing agent. Thus, the consumer can easily recognize when the dishwashing agent has been used up and therefore the usage cycle of the dishwashing pad has ended.

In various embodiments, one side of the dishwashing pad can be comparatively rougher than the other side. The cloth thus can be used for widely different types of soiling and dishes, for example pans, pots, plates, and glasses. The rough side is used to remove even tenacious soiling, such as baked or dried-up soiling on pans, pots, baking molds, and the like, while the softer side is suitable for gently cleaning sensitive dishware, such as glasses.

The dishwashing pad can have any shape. The dishwashing pad preferably has the shape of a dishwashing pad or of a sponge cloth and is suitable for one-handed use in dishwashing agent solution, for example in a dishwashing sink, or under running water. “Dishwashing pad,” as used herein, refers in particular to a rectangular, square, oval, or round sponge cloth that can be comfortably grasped and used with one hand. The fact that the dishwashing pad is intended for one-time use means that the dishwashing pad is disposed of after a dishwashing process and is not used a second time. “Dishwashing process” refers herein to the manual washing of a given amount of dirty dishes until substantially all soiling has been removed.

Because of the one-time use, the dishwashing pad is especially hygienic and neither the formation of bad odors nor the colonization of bacteria in the dishwashing pad occurs. Furthermore, the coating with dishwashing agent and the two-sided design of the dishwashing pad with different roughnesses enable all-in-one use, i.e., separate dishwashing aids, such as a sponge or a brush, and a separate dishwashing agent can be forgone.

Furthermore, the indicator has the advantage that the consumer can clearly recognize when the dishwashing agent has been used up and therefore the end of the usage cycle of the dishwashing pad has been reached.

In the use of the dishwashing pad, either the dishwashing pad or the dishes to be cleaned are brought into contact with water, for example running water or water in a dishwashing sink, and then the dishwashing pad is brought into contact with the wet dishes or the wet dishwashing pad is brought into contact with the dishes. The dishes can then be cleaned by manually guiding the cloth over the surface of the dishes, particularly by means of wiping or scratching motion and the application of pressure. If the dishwashing pad is brought into contact with water in a dishwashing sink, a cleaning solution for the subsequent washing process can be produced by soaking the cloth with water and squeezing the cloth out several times, wherein the dishwashing agent composition is at least partially removed. Alternatively, the cleaning can occur under running water, wherein dishwashing agent is successively removed from the surface of the cloth. The dishes can be rinsed off or soaked with water before the actual washing process in order to make the removal of the soiling in the following step easier.

After the dishwashing, the dishes can be rinsed off with water, preferably clean water, and thereafter either allowed to dry or actively dried off, for example with a dry cloth.

Thereafter, the dishwashing pad can also be used to clean the dishwashing sink or other surfaces, more particularly surfaces and working areas in the adjacent kitchen region.

The dishwashing pad has preferably two sides, wherein the two sides can have different surface conditions. In particular, the one side is rougher than the other side. In this characteristic, the dishwashing pad is similar to generally available domestic sponges that likewise have a significantly rougher side and a softer side. The rougher side and the softer side can, for example, be easily distinguished by test subjects, wherein the differences in the roughness are of such an extent that said differences can be readily correctly assigned by a majority of the test subjects.

The dishwashing pad can be composed of all materials known and suitable for this purpose. The dishwashing pad preferably is composed of a nonwoven fabric, wherein the expression “nonwoven fabric” is directed very generally towards materials consisting largely of unwoven fibers. Paper materials can also be suitable. However, the dishwashing pad can also be composed of woven cloth or sponge material. In general, it is not intended that the expression “dishwashing pad” used herein means that a certain type of material is mandatory. Rather, it is intended that all of these material forms are encompassed by the described invention. The material is preferably water-permeable, flexible, and elastic and preferably reassumes its original shape after a compressive load is removed, for example after manual squeezing out. Thus, the dishwashing pad can be a rag, a cloth, a sponge, a sponge cloth, or the like.

The material can be of synthetic or natural origin and in particular can contain synthetic or natural fibers. Natural fibers include fibers that are naturally available without having been modified, regenerated, or artificially produced and originate, for example, from plants. Preferred examples of natural fiber materials include, without being limited thereto, cellulose fibers, including pulp, cotton, hemp, jute, flax, and combinations thereof. In contrast, “synthetic” means that the material is mainly composed of artificially produced or processed/modified natural materials. Non-restrictive examples of synthetic materials that can be useful herein include those that are selected from acrylic compounds, such as Acrilan, Creslan, and Orlon, cellulose esters, such as cellulose acetate, polyamides, such as nylon, polyesters, such as Fortrel, Kodel, Dacron, PBT, and PET, polyolefins, such as polyethylene and polypropylene, polyvinyl alcohol, polyvinyl acetate, polyether, and combinations thereof. In particular, fibers composed of the previously mentioned materials are used. Fibers composed of these and other materials and the nonwoven fabrics produced from said fibers are known in the prior art and are commercially available.

In addition to the mentioned fiber materials, the dishwashing pad can contain further constituents or materials that give the dishwashing pad the desired mechanical properties, such as binders that bond the fibers. Such binders are, more particularly, polymeric binders, preferably latex systems, more particularly water-based latex systems.

The material is preferably an airy, wadding-like or sponge-like material.

It is preferred that the dishwashing pad is composed at least partially of materials that are biodegradable and therefore are as harmless as possible for reasons of environmental protection. Such materials include all the natural materials mentioned above and some of the synthetic materials, such as certain cellulose esters. Preferred synthetic materials are polypropylene-based nonwoven fabrics. Preferred natural or biodegradable materials are cellulose-based nonwoven fabrics.

The dishwashing pad can also be composed of two different materials, particularly in such a way that the side having a rough surface is composed of a different material than the side having the smoother surface. The corresponding materials can be adhesively bonded, woven, or otherwise connected to each other to form the dishwashing pad.

The rough side of the dishwashing pad has a surface having greater scouring action than the less rough side and is also referred to below as the scouring side, whereas the other side is simply referred to as the cleaning side. As already described above, the scouring side is useful for removing tenacious soiling. This side is preferably composed of synthetic fibers, such as polyamide, polyethylene, and polypropylene fibers and mixtures thereof. The arrangement of the fibers can be random, but it is preferred that the fibers are laid over each other and form a nonwoven fabric.

When reference is made herein to the “sides” of the dishwashing pad, the two opposite surfaces having the greatest extent in the x direction and y direction (laterally) are meant by this in the case of a cloth- or rag-shaped object (wherein the thickness then indicates the extent in the z direction). In the case of such dishcloths or dishwashing pads, it is typical that the aspect ratio, i.e., the ratio of the height to the smallest lateral extent, is small, particularly less than 0.1.

In the dishcloths of the invention, the dishwashing agent composition is applied at least to a part of the surface of the dishwashing pad. Said surface is preferably the surface of one of the sides of the dishwashing pad that are described above, especially preferably the surface of both sides. In various embodiments, the composition is applied to the surface of the dishwashing pad after the dishwashing pad has been produced. The method of application is not restricted. For example, all possible methods for applying liquid compositions are considered. These include, among other things, printing, spray coating, spin coating, dipping, extrusion, etc.

The coating can occur evenly or unevenly. In the latter case, the coating can vary with regard to the amount, i.e., thickness, of the coating, and with regard to the distribution. In this way, the coating can assume the form of a pattern or of a symbol or of writing. Parts of the surface, including parts of the surface of a side, can have no coating.

The dishwashing agent is preferably used in the form of a highly viscous paste or in the form of a melt. Depending on the form of the dishwashing agent, the dishwashing pad can feel moist or dry. However, it is preferred that the dishwashing pad feels substantially dry.

The amount of dishwashing agent that is used depends on what amounts of dishes should be washed therewith. Preferably, amounts in the range of 0.5 to 5 g are used for each dishwashing pad. The coated area is preferably approximately 25 to 80 cm², especially preferably 35 to 55 cm².

The dishwashing agent composition can comprise a series of ingredients that are known as such in the prior art. In addition to the known and routinely used ingredients, which comprise in particular surfactants, builders, enzymes, acids, bases, salts, complexing agents, polymers, fillers, bleaches, and mixtures thereof, the dishwashing agent preferably contains a thickener, which acts as a viscosity regulator and adhesion promoter.

In general, the thickener can comprise any compound that is typically used as a viscosity regulator in detergents and cleaning agents, such as organic natural thickening agents (agar-agar, carrageenan, tragacanth, gum arabic, alginates, pectins, polyoses, guar gum, locust bean gum, starch, dextrins, gelatin, casein), organic modified natural materials (carboxymethyl cellulose and other cellulose ethers, hydroxyethyl and hydroxypropyl cellulose and the like, kernel meal ethers), organic fully synthetic thickening agents (polyacrylic and polymethacrylic compounds, vinyl polymers, polycarboxylic acids, polyethers, polyimines, polyamides, polyisobutylene succinic acid esters, hydrogenated polystyrene derivatives, olefin homopolymers, olefin copolymers, vinyl methyl ether/maleic acid copolymers, alkyl dimethyl amine oxides, aryl ethoxylates, alkylaryl ethoxylates), and inorganic thickening agents (polysilicic acids, phyllosilicates, clay minerals such as montmorillonites, zeolites, silicic acids).

Polysaccharides or heteropolysaccharides especially suitable as thickeners are the polysaccharide gums, such as gum arabic, agar, alginates, carrageenans and salts thereof, guar, guaran, gum tragacanth, gellan gum, ramsan, dextrane, or xanthan gum, and derivatives thereof, such as propoxylated guar, and mixtures thereof. Other polysaccharide thickeners, such as starches or cellulose derivatives, can be used alternatively to, but preferably in addition to, a polysaccharide gum, for examples starches of widely different origin and starch derivatives, such as hydroxyethyl starch, starch phosphate esters, or starch acetates, or carboxymethyl cellulose or the sodium salt thereof, methyl, ethyl, hydroxyethyl, hydroxypropyl, hydroxypropyl methyl or hydroxyethyl methyl cellulose or cellulose acetate.

Suitable acrylic acid polymers are, for example, high-molecular-weight homopolymers of acrylic acid cross-linked with a polyalkenyl polyether, more particularly with an allyl ether of sucrose, pentaerythritol, or propylene, (INCI Carbomer), which are also referred to as carboxyvinyl polymers. Such polyacrylic acids are available, among other things, from the company BFGoodrich under the tradename Carbopol®.

The following acrylic acid copolymers are also suitable polymers: (i) copolymers of two or more monomers from the group of acrylic acid, methacrylic acid, and simple esters thereof preferably formed with C₁₋₄ alkanols (INCI Acrylates Copolymer), to which copolymers the copolymers of methacrylic acid, butyl acrylate, and methyl methacrylate (CAS 25035-69-2) or of butyl acrylate and methyl methacrylate (CAS 25852-37-3), for example, belong and which copolymers are available, for example, from the company Rohm & Haas under the tradenames Aculyn® and Acusol® and from the company Degussa (Goldschmidt) under the tradename Tego® Polymer; (ii) cross-linked high-molecular-weight acrylic acid copolymers, to which, for example, the copolymers of C₁₀₋₃₀ alkyl acrylates cross-linked with an allyl ether of sucrose or of pentaerythritol with one or monomers from the group of acrylic acid, methacrylic acid, and simple esters thereof preferably formed with C₁₋₄ alkanols (INCI Acrylates/C₁₀₋₃₀ Alkyl Acrylate Crosspolymer) belong and which are available, for example, from the company BFGoodrich under the tradename Carbopol®.

Phyllosilicates usable as inorganic thickening agents include, for example, the magnesium or sodium magnesium phyllosilicates from the company Solvay Alkali available under the tradename Laponite®, more particularly Laponite® RD or Laponite® RDS, and the magnesium silicates from the company Sud-Chemie, especially Optigel® SH.

In addition to the mentioned thickeners, substances that are typically used as adhesives can also be used. These include, for example, adhesive polymers.

The dishwashing agent composition can contain any surfactant that is known for use in dishwashing agents. Preferably, at least one surfactant is contained that is selected from the group comprising: non-ionic surfactants, anionic surfactants, cationic surfactants, and amphoteric surfactants. The at least one surfactant is preferably selected from the group of the non-ionic surfactants, the anionic surfactants, the amphoteric surfactants, and mixtures thereof.

Within the context of the invention, non-ionic surfactants can be alkoxylates such as polyglycol ethers, fatty alcohol polyglycol ethers, alkylphenol polyglycol ethers, end-capped polyglycol ethers, mixed ethers and hydroxy mixed ethers, and fatty acid polyglycol esters. Also usable are ethylene oxide/propylene oxide block copolymers, fatty acid alkanolamides, and fatty acid polyglycol ethers. A further important class of non-ionic surfactants that can be used according to the invention is the polyol surfactants and here especially the glycosurfactants, such as alkyl polyglycosides and fatty acid glucamides. Especially preferred are the alkyl polyglycosides, more particularly the alkyl polyglucosides, wherein especially preferably the alcohol is a long-chain fatty alcohol or a mixture of long-chain fatty alcohols having branched or unbranched C₈ to C₁₈ alkyl chains and the degree of oligomerization (DP) of the sugars is between 1 and 10, preferably 1 to 6, more particularly 1.1 to 3, extremely preferably 1.1 to 1.7, for example C₈₋₁₀ alkyl 1.5 glucoside (DP of 1.5). In addition, the fatty alcohol alkoxylates (fatty alcohol polyglycol ethers) are also preferred, more particularly unbranched or branched, saturated or unsaturated C₈₋₂₂ alcohols alkoxylated with ethylene oxide (EO) and/or propylene oxide (PO) and having a degree of alkoxylation of up to 30, preferably ethoxylated C₁₂₋₂₂ fatty alcohols having a degree of ethoxylation of less than 30, preferably 12 to 28, more particularly 20 to 28, especially preferably 25, for example C₁₆₋₁₈ fatty alcohol ethoxylates having 25 EO units.

The composition can preferably also contain at least one anionic surfactant. Preferred anionic surfactants are herein fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates, and lignosulfonates. Also usable within the context of the present invention are fatty acid cyanamides, sulfosuccinates (sulfosuccinic acid esters), more particularly sulfosuccinic acid mono- and di-C₈-C₁₈-alkyl esters, sulfosuccinamates, sulfosuccinamides, fatty acid isethionates, acylamino alkane sulfonates (fatty acid taurides), fatty acid sarcosinates, ether carboxylic acids, and alkyl (ether) phosphates, and α-sulfo fatty acid salts, acyl glutamates, monoglyceride disulfates, and alkyl ethers of glycerol disulfate.

Preferred within the context of the present invention are the alkane sulfonates, more particularly secondary alkane sulfonates, fatty alcohol sulfates, and/or fatty alcohol ether sulfates. Secondary alkane sulfonates are products of sulfation reactions on secondary alcohols, and fatty alcohol sulfates are products of sulfation reactions on corresponding alcohols, while fatty alcohol ether sulfates are products of sulfation reactions on alkoxylated alcohols. By alkoxylated alcohols, a person skilled in the art generally understands the reaction products of alkylene oxide, preferably ethylene oxide, with alcohols, in the sense of the present invention preferably with long-chain alcohols. In general, a complex mixture of addition products of different degrees of ethoxylation results from n moles of ethylene oxide and one mole of alcohol, depending on the reaction conditions. A further embodiment of the alkoxylation consists in the use of mixtures of the alkylene oxides, preferably the mixture of ethylene oxide and propylene oxide. Preferred fatty alcohol ether sulfates are the sulfates of low-ethoxylated fatty alcohols having 1 to 4 ethylene oxide (EO) units, more particularly 1 to 2 EO units, for example 1.3 EO units.

The anionic surfactants are preferably used as sodium salts but can also be contained as other alkali metal salts or alkaline-earth metal salts, for example magnesium salts, and in the form of ammonium salts or mono-, di-, tri-, or tetraammonium salts, in the case of the sulfonates also in the form of the corresponding acid thereof, for example dodecylbenzenesulfonic acid.

In addition to the previously mentioned surfactant types, the dishwashing agent can also contain cationic surfactants and/or amphoteric surfactants.

Suitable amphoteric surfactants are, for example, betaines of the formula (Rⁱⁱⁱ)(R^{iv})(R^{v})N⁺CH₂COO⁻, in which Rⁱⁱⁱ means an alkyl residue having 8 to 25, preferably 10 to 21, carbon atoms that is possibly interrupted by heteroatoms or heteroatom groups and R^{iv} and R^{v} mean identical or different alkyl residues having 1 to 3 carbon atoms, more particularly C₁₀-C₁₈ alkyl dimethyl carboxymethyl betaine and C₁₁-C₁₇ alkyl amido propyl dimethyl carboxymethyl betaine.

Suitable cationic surfactants are, among other things, the quaternary ammonium compounds of the formula (R^{vi})(R^{vii})(R^{viii})(R^{ix})N⁺X⁻, in which R^{vi} to R^{ix} stand for four identical or different, more particularly two long-chain and two short-chain, alkyl residues and X⁻ stands for an anion, more particularly a halide ion, for example didecyl dimethyl ammonium chloride, alkyl benzyl didecyl ammonium chloride, and mixtures thereof. Further suitable cationic surfactants are the quaternary surface-active compounds, particularly having a sulfonium, phosphonium, iodonium, or arsonium group, that are also known as antimicrobial active ingredients. By the use of quaternary surface-active compounds having antimicrobial action, the agent can be equipped with antimicrobial action or the antimicrobial action of the agent possibly already present because of other ingredients can be improved. In order to avoid possible incompatibilities of the cationic surfactants with the contained anionic surfactant(s), cationic surfactant that is as compatible with anionic surfactants as possible and/or as little cationic surfactant as possible is used or, in a special embodiment of the invention, cationic surfactants are completely forgone.

In preferred embodiments, the dishwashing agent contains at least one fatty alcohol ether sulfate, at least one secondary alkane sulfonate, and at least one betaine. In various embodiments, the at least one fatty alcohol ether sulfate is a C₁₀-C₁₈, preferably a C₁₂-C₁₄, fatty alcohol ether sulfate having 2 EO units. C₁₄-C₁₇ secondary alkane sulfonates are preferred as secondary alkane sulfonates. C₈-C₁₈ alkyl dimethyl amido propyl betaine, for example, is suitable as the betaine.

In various embodiments, the at least one fatty alcohol ether sulfate is contained in an amount of 10 to 35 wt %, preferably 15-25 wt %, with respect to the total weight of the dishwashing agent.

The secondary alkane sulfonate is preferably contained in an amount between 1 and 5 wt %, preferably 2 to 3 wt %, with respect to the total weight of the dishwashing agent.

The betaine can be contained in an amount of 5 to 30 wt %, preferably 15 to 25 wt %, with respect to the total weight of the dishwashing agent.

In various embodiments, 15 to 50 wt %, preferably 20 to 45 wt %, of surfactants are contained in the dishwashing agent in total. The remainder of the cleaning agent block is composed particularly of thickeners, such as PEG, in various embodiments.

In addition to the previously mentioned components, the dishwashing agent can contain one or more further common auxiliary substances and additives. These include, for example, organic adjusting agents (particularly sugar, sugar alcohols, glycerol, glycols, and polymers thereof), hydrophobing agents (such as paraffin), UV stabilizers, perfume oils, pearlizing agents (INCI Opacifying Agents; such as glycol distearate, for example Cutina® AGS from the company Cognis, or mixtures containing glycol distearate, for example Euperlane® from the company Cognis), further opacifiers, dyes, corrosion inhibitors, bittering agents, preservatives (e.g., the technical 2-bromo-2-nitropropane-1,3-diol also referred to as bronopol (CAS 52-51-7), which is commercially available for example as Myacide® BT or as Boots Bronopol BT from the company Boots, or also mixtures containing bronopol such as Preventol® (from Lanxess) or Parmetol® (from Schülke & Mayr)), disinfectants, pH adjusters, fragrances, and skin-feel-improving or skin care additives (e.g., dermatologically active substances such as vitamin A, vitamin B2, vitamin B12, vitamin C, vitamin E, D-panthenol, sericerin, collagen partial hydrolysate, various plant protein partial hydrolysates, protein hydrolysate/fatty acid condensates, liposomes, cholesterol, plant and animal oils such as lecithin, soybean oil, etc., plant extracts such as aloe vera, azulene, witch-hazel extracts, algae extracts, etc., allantoin, AHA complexes, glycerol, urea, quaternized hydroxyethyl cellulose), added substances for improving the processing and drying behavior or for stabilization. These auxiliary substances and additives are contained particularly in amounts of typically not more than 5 wt %.

The dishwashing agent can contain one or more fragrances, preferably in an amount of 0.01 to 10 wt %, more particularly 0.05 to 8 wt %, especially preferably 0.1 to 5 wt %. d-Limonene can be contained as a perfume component. In another embodiment, the cleaning agent block according to the invention contains a perfume consisting of ethereal oils (also referred to as essential oils). For example, pine oil, citrus oil, jasmine oil, patchouli oil, rose oil, or ylang ylang oil can be used as such in the sense of this invention. Likewise suitable are clary sage oil, chamomile oil, lavender oil, clove oil, melissa oil, mint oil, cinnamon leaf oil, linden blossom oil, juniper berry oil, vetiver oil, olibanum oil, galbanum oil, and labdanum oil, as well as oil of orange blossoms, neroli oil, orange peel oil, and sandalwood oil. Further odorous substances typically used in detergents and cleaning agents are likewise suitable for use in the cleaning agent block according to the invention, for example further ethereal oils, esters, alcohols, aldehydes, or terpenes.

In one embodiment of the invention, the dishwashing agent contains one or more antimicrobial active ingredients, preferably in an amount of 0.01 to 1 wt %, preferably 0.02 to 0.8 wt %, more particularly 0.05 to 0.5 wt %, especially preferably 0.1 to 0.3 wt %, extremely preferably 0.2 wt %.

For example, antimicrobial ingredients from the groups of the alcohols, aldehydes, antimicrobial acids and salts thereof, carboxylic acid esters, acid amides, phenols, phenol derivatives, diphenyls, diphenyl alkanes, urea derivatives, oxygen and nitrogen acetals and formals, benzamidines, isothiazoles and derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butylcarbamate, iodine, iodophors, compounds that release active chlorine, and peroxides are suitable according to the invention. Preferred antimicrobial active ingredients are preferably selected from the group comprising ethanol, n-propanol, i-propanol, 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylenebis(6-bromo-4-chlorophenol), 2,4,4′-trichloro-2′-hydroxydiphenyl ether, N-(4-chlorophenyl)-N-(3,4-dichlorophenyl)-urea, N,N′-(1,10-decanediyldi-1-pyridinyl-4-ylidene)-bis-(1-octanamine)-dihydrochloride, N,N′-bis-(4-chlorophenyl)-3,12-diimino-2,4,11,13-tetraazatetradecanediimideamide, antimicrobial quaternary surface-active compounds, guanidines, and sodium dichloroisocyanurate (DCI, 1,3 -dichloro-5H-1,3,5-triazine-2,4,6-trione sodium salt). Preferred antimicrobially active surface-active quaternary compounds contain an ammonium, sulfonium, phosphonium, iodonium, or arsonium group. Furthermore, antimicrobially active ethereal oils can also be used, which simultaneously scent the cleaning product. However, especially preferred antimicrobial active ingredients are selected from the group comprising salicylic acid, quaternary surfactants, more particularly benzalkonium chloride, peroxo compounds, more particularly hydrogen peroxide, alkali metal hypochlorite, sodium dichloroisocyanurate, and mixtures thereof.

Preservatives can also be contained. Essentially, the substances mentioned in the case of the antimicrobial active ingredients can be used as preservatives.

Suitable corrosion inhibitors (INCI Corrosion Inhibitors) are, for example, the following substances named according to INCI: Cyclohexylamine, Diammonium Phosphate, Dilithium Oxalate, Dimethylamino Methylpropanol, Dipotassium Oxalate, Dipotassium Phosphate, Disodium Phosphate, Disodium Pyrophosphate, Disodium Tetrapropenyl Succinate, Hexoxyethyl Diethylammonium, Phosphate, Nitromethane, Potassium Silicate, Sodium Aluminate, Sodium Hexametaphosphate, Sodium Metasilicate, Sodium Molybdate, Sodium Nitrite, Sodium Oxalate, Sodium Silicate, Stearamidopropyl Dimethicone, Tetrapotassium Pyrophosphate, Tetrasodium Pyrophosphate, Triisopropanolamine.

The substances referred to as rinse-off regulators serve primarily to control the consumption of the agents during use in such a way that the intended service life is adhered to. Preferably solid long-chain fatty acids, such as stearic acid, but also salts of such fatty acids, fatty acid ethanolamides, such as coconut fatty acid monoethanolamide, or solid polyethylene glycols, such as those with molecular weights between 10,000 and 50,000, are suitable as regulators.

The pH value of the agents according to the invention can be set by means of common pH regulators, such as citric acid or NaOH. It is herein preferred, mainly because of the required hand compatibility, that a 10% aqueous solution of the agent has a pH value in a range of 3 to 12, preferably 5 to 11, more particularly 4 to 8.

In order to set and/or stabilize the pH value, the agent according to the invention can also contain one or more buffer substances (INCI Buffering Agents), typically in amounts of 0.001 to 5 wt %, preferably 0.005 to 3 wt %, more particularly 0.01 to 2 wt %, especially preferably 0.05 to 1 wt %, extremely preferably 0.1 to 0.5 wt %, for example 0.2 wt %. Buffer substances that are simultaneously complexing agents or even chelating agents (chelators, INCI Chelating Agents) are preferred. Especially preferred buffer substances are citric acid and the citrates, more particularly the sodium and potassium citrates, such as trisodium citrate.2H₂O and tripotassium citrate.H₂O.

The dishwashing agent can contain one or more dyes (INCI Colorants) as further ingredients. Both water-soluble and oil-soluble dyes can be used as dyes, wherein the compatibility with further ingredients, for example bleaches, must be considered and the dye used should not substantively affect metal and ceramic even in the case of long exposure. However, water-soluble dyes are herein preferred. The dyes are preferably contained in an amount of 0.0001 to 2 wt %, more particularly 0.0005 to 1 wt %, especially preferably 0.001 to 0.5 wt %. As already described above, such dyes can be added to the dishwashing agent coatings in amounts that are sufficient to enable visual perception by the consumer. The dyes are preferably formulated in such a way that they are removed together with the dishwashing agent over the period of time of the washing operation and thus indicate the consumption of the dishwashing agent and also the end of the usability of the dishwashing pad, i.e., the end of the usage cycle. The dyes are removed preferably to the same extent, i.e., at the same rate, as the dishwashing agent. Alternatively, the dye can also be formulated in such a way that the dye is not removed until the dishwashing agent has been completely used up. In this case, the consumer could visually perceive the color as long as dishwashing agent is still present and, as soon as the dishwashing agent is all used up, the dye would also be removed immediately and would indicate that dishwashing agent is no longer present.

In a further aspect, the invention also relates to the use of the dishcloths described herein for manually washing dishes and methods for cleaning hard surfaces, more particularly for manually washing dishes, by using the dishwashing pad described herein. Such uses and methods comprise the steps that are common in the case of such uses and methods, particularly:
(i) bringing the dishwashing pad and/or the dishes to be cleaned into contact with water, more particularly flowing water, preferably over or in a dishwashing sink;
(ii) bringing the surface of the dishes that is to be cleaned into contact with the dishwashing pad, particularly mechanically by wiping or scratching with the dishwashing pad; and
(iii) possibly rinsing off the dishes with water.

Thereafter, a step for drying the dishes can also follow, as already described above.

All embodiments disclosed herein in relation to the dishwashing pad are of course also applicable to the described uses and methods, and vice versa.

### EXAMPLES

### Example 1

Dishwashing agents in the form of a melt having the compositions stated in table 1 were applied to a polypropylene nonwoven-fabric dishwashing pad either extensively in a circular shape (50.24 cm², 3-3.5 g) or as writing (40 cm², 1.5-2 g). The compositions can be found in the following table, in which the amount specifications are in wt % of active substance.

| | 1 | 2 | 3 | 4 |
|---|---|---|---|---|
| C₁₂₋₁₄ fatty alcohol ether sulfate, | 18.6 | 18.6 | 18.6 | 18.6 |
| 2 EO units (Texapon ® N70) | | | | |
| C₁₄₋₁₇ SAS sodium salt (Hostapur ® | 2.9 | 2.9 | 2.9 | 2.9 |
| SAS60) | | | | |
| C₈₋₁₈ alkyl dimethyl amido propyl | 18.6 | 18.6 | 18.6 | 18.6 |
| betaine (Tego ® Betain C60) | | | | |
| Polyethylene glycol (PEG 400) | 6.0 | 6.0 | 6.0 | 6.0 |
| Polyethylene glycol (PEG 4000) | 50.0 | 50.0 | 50.0 | 50.0 |
| Polygel ® W400 (polyacrylate | 2.0 | 1.9 | 1.9 | 1.3 |
| thickener) | | | | |
| Perfume | 1.9 | 1.9 | 2.0 | 2.0 |
| Dye | — | see | see | see |
| | | below | below | below |
| Antimicrobial active ingredient | — | 0.1 | — | — |
| (Parmetol A28S) | | | | |

The compositions contained the following dyes:
2: C.I. 42090 Acid Blue 9, Basacid Blue 756 liquid (0.01%)
3: C.I. 42051 Acid Blue 3, Basacid blue V 20 liquid (0.003%)
   C.I. 19140 Tartrazin® yellow (0.0037%)
4: Acid red 18, Sanolin Ponceau® liquid (0.6%)

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A dishwashing pad, which is intended for one-time use for manually washing dishes, characterized in that at least one surface of the dishwashing pad is at least partially coated with a dishwashing agent, wherein the dishwashing agent coating has a visually perceptible indicator, comprising a dye or a dye mixture, that indicates the consumption of the dishwashing agent and/or the end of the usage cycle.

2. The dishwashing pad according to claim 1, characterized in that one side of the dishwashing pad is comparatively rougher than the other side.

3. The dishwashing pad according to claim 1, characterized in that both sides of the dishwashing pad are coated with a dishwashing agent.

4. The dishwashing pad according to claims 1, characterized in that the dishwashing pad is at least partially composed of biodegradable material.

5. The dishwashing pad according to one of claim 1, characterized in that the visually perceptible indicator is removed from the dishwashing pad together with and to the same extent as the dishwashing agent, during the dishwashing.

6. A method for manually washing dishes, by using the dishwashing pad according to claim 1, comprising:
(i) bringing the dishwashing pad and/or the dishes to be cleaned into contact with water, over or in a dishwashing sink;
(ii) bringing the surface of the dishes that is to be cleaned into contact with the dishwashing pad, and
(iii) possibly rinsing off the dishes with water.
